(19) United States
(12) Patent Application Publication
(10) Pub. No.: US 2014/0225476 A1
(43) Pub. Date: Aug. 14, 2014

(54) SYSTEMS AND METHODS FOR HARMONIC REDUCTION IN CAPACITIVE MICROMACHINED ULTRASONIC TRANSDUCERS BY GAP FEEDBACK LINEARIZATION

(71) Applicants: Levent F. Degertekin, Atlanta, GA (US); Sarp Satir, Atlanta, GA (US)

(72) Inventors: Levent F. Degertekin, Atlanta, GA (US); Sarp Satir, Atlanta, GA (US)

(21) Appl. No.: 14/126,959

(22) PCT Filed: Jun. 18, 2012
(86) PCT No.: PCT/US12/43029

§ 371 Date: Mar. 18, 2014

Related U.S. Application Data
(60) Provisional application No. 61/498,177, filed on Jun. 17, 2011.

(51) Int. Cl. B06B 1/02

(52) U.S. Cl. CPC B06B 1/0292
USPC 310/309

(57) ABSTRACT

Systems and methods for providing increased CMUT imaging performance are disclosed. The system can comprise CMUT electronics with integrated or derived gap feedback. In this manner, the response of the CMUT membrane can be linearized to improve pressure output and/or harmonic distortion. The system can comprise a CMUT with series resistance to improve linearity. The system can also comprise a CMUT with series induction-resistance for improved linearity at reduced voltages. A method for linearizing CMUT response is also disclosed. The method can comprise providing a signal to the CMUT that is inversely proportional the gap between the CMUT membrane and the substrate on which the CMUT is fabricated.

### CROSS-REFERENCE TO RELATED APPLICATIONS

This application priority to, and the benefit of, U.S. Provisional Patent Application No. 61/498,177, filed Jun. 17, 2011, of the same title. This application is incorporated herein by reference as if set out fully below.

### BACKGROUND

1. Technical Field

The present invention relates generally to capacitive micromachined ultrasonic transducers (CMUTs), and specifically to CMUTs with improved response through harmonic reduction.

2. Background of Related Art

Nonlinear harmonic imaging is a recent imaging technique that offers advantages over conventional ultrasound imaging methods. Using the harmonic content in the received echo signals, for example, selective nonlinear images of contrast agents and tissue can be constructed. Harmonic imaging generally uses narrowband pulses at a fundamental frequency, f₀, during transmit functions and then uses harmonic content within the received echo signals for image reconstruction.

A variety of methods have been introduced in an effort to enhance the harmonic information from the received echoes by modifying the transmit signals. Ultrasound images can be reconstructed, for example, using 2f₀, or higher order, harmonic content of the echo signals, because this offers higher lateral and contrast resolution, with lower side and grating lobes, when compared to conventional imaging utilizing f₀. In addition, because the nonlinear waves originate within the field of view, aberration artifacts are reduced because there is only one-way propagation rather than two-way propagation, as in conventional imaging.

Capacitive micromachined ultrasonic transducers (CMUTs) offer distinct advantages as an alternative to piezoelectric transducers in terms of bandwidth, cost, ease of fabrication, and integration with electronics. The wider bandwidth of the transducer allows for the use of the same element as a transmitter at f₀ and as a receiver for higher harmonics. CMUTs are nonlinear transducers, however, because the electrostatic force applied to the transducer membrane is a nonlinear function of the input voltage and the instantaneous gap between the electrodes driving the transducer. This nonlinear dependence of the electrostatic force results in a collapse phenomenon and distortion of the transmitted ultrasound wave. This CMUT nonlinearity can be disadvantageous for harmonic imaging, because the harmonic content of the transmitted signal can contribute to the harmonic content in the received signal.

What is needed, therefore, is a method to reduce the harmonic content in the transmitted signal of CMUTs for harmonic imaging. These methods should address the voltage square dependence of the electrostatic force as a source of nonlinearity by modifying the electrical input signal. The method can apply additional signals at various frequencies for linear and nonlinear cancellation of the harmonic component of the transmitted signal.

Embodiments of the present invention, therefore, relate to a series impedance added to the CMUT, for example, to reduce the total harmonic distortion of the transmitted signal by shaping the input signal applied to the CMUT via instantaneous gap feedback. CMUTs with a series capacitor, a series resistor, and a series resistor-inductor pair can also be used to shape the signals, reduce distortion, and improve image quality and resolution.

### SUMMARY

Embodiments of the present invention relate generally to a system and method for ultrasound imaging, and specifically to a system and method for increasing output pressure and reducing distortion using capacitive micromachined ultrasonic transducers (CMUTs) with additional electronics. Embodiments of the present invention provide improved imaging at reduced input voltages. Embodiments of the present invention can utilize multiple configurations including, but not limited to, resistive and/or inductive-resistive gap feedback electronics.

Embodiments of the present invention can comprise a device for ultrasound imaging. In some embodiments, the device can comprise a capacitive micromachined ultrasonic transducer (CMUT) disposed on a substrate and comprising a membrane, and one or more control components. In some embodiments, the control components can apply a first signal to the CMUT that is inversely proportional to a gap between the membrane and the substrate. The first signal can comprise a DC voltage signal, an AC voltage signal, or a combination thereof.

Embodiments of the present invention can further gap circuitry for determining the gap between the membrane and the substrate. The control components can be disposed, for example and not limitation, on the same substrate as the CMUT or on a different substrate. In some embodiments, the control components can comprise one or more resistors. In other embodiments, the control components can comprise one or more resistors and one or more inductors. In still other embodiments, the device can comprise a first electrode disposed on the membrane and a second electrode disposed on the substrate and the first signal is a voltage differential applied across the first and second electrodes.

Embodiments of the present invention can also comprise a device for ultrasound imaging comprising a substrate, a capacitive micromachined ultrasonic transducer (CMUT) comprising a membrane and disposed on the substrate, a first electrode disposed within the membrane and configured to receive ultrasonic signals for transmission and to receive bias voltages for positioning the membrane for transmission and reception of ultrasonic waves, a second electrode disposed on the substrate and set off from the membrane to define a cavity positioned beneath the membrane, and one or more control components. In this configuration, the membrane can fluctuate in the cavity based on the application of an electrical signal across the first electrode and the second electrode. In some embodiments, the feedback components can apply a signal to the first and second electrodes that is inversely proportional to a gap between the membrane and the substrate.

In some embodiments, the device can further comprise feedback circuitry for determining the gap between the membrane and the substrate. In other embodiments, the device can further comprise a third electrode disposed within the membrane and configured to receive ultrasonic signals for transmission and to receive bias voltages for positioning the membrane for transmission and reception of ultrasonic waves.

Embodiments of the present invention can also comprise a method for ultrasound imaging comprising providing a CMUT with a membrane and disposed on a substrate, applying a first signal to the CMUT that is inversely proportional to a gap between the membrane and the substrate to improve the linearity of the motion of the membrane. In some embodiments, the method can further comprise determining the gap between the substrate and the membrane using feedback circuitry. The feedback circuitry can comprise, for example one or more inductors in series with the CMUT. In some embodiments, the first signal can comprise an AC component at approximately one half the desired pressure output and no DC component.

These and other objects, features and advantages of the present invention will become more apparent upon reading the following specification in conjunction with the accompanying drawing figures.

### BRIEF DESCRIPTION OF THE DRAWINGS

FIG. 1 depicts a 1-D nonlinear capacitive micromachined ultrasonic transducer (“CMUT”) model as a parallel plate capacitor and a baffled piston, in accordance with some embodiments of the present invention.

FIG. 2 depicts a nonlinear transient model implemented in Simulink for an arbitrary input signal V(t) and generated surface pressure p(t), in accordance with some embodiments of the present invention.

FIG. 3 depicts a simulated impulse response of the CMUT, where V(t) is a pulse with V_{DC}=120 V, 3-ns pulse width, and 120-V amplitude and the normalized frequency spectrum of the average surface pressure, in accordance with some embodiments of the present invention.

FIG. 4 depicts the magnitude of the f₀=20 MHz component and the ratio between 20- and 40-MHz components as a function of V_{DC} and V_{AC} at an excitation frequency of 20 MHz, in accordance with some embodiments of the present invention.

FIG. 5 depicts the magnitude of the f₀=20 MHz component and the ratio between 20- and 40-MHz components as a function of V_{AC} with no V_{DC} applied at an excitation frequency of 10 MHz, in accordance with some embodiments of the present invention.

FIG. 6 is a block diagram of the nonlinear gap feedback topology, in accordance with some embodiments of the present invention.

FIGS. 7a and 7b depict the magnitude spectrum of generated surface pressure for 10-MHz, 150-Vₚₑₐₖ excitation signal with and without feedback, respectively, with corresponding a for the same pressure at 20 MHz, in accordance with some embodiments of the present invention.

FIG. 8 depicts an electrical circuit with the addition of series impedance to the CMUT capacitance, in accordance with some embodiments of the present invention.

FIG. 9 depicts a Simulink model with the addition of a series feedback capacitor, C_{S}, in accordance with some embodiments of the present invention.

FIG. 10 depicts a Simulink model with the addition of a series feedback resistor, R_{S}, in accordance with some embodiments of the present invention.

FIG. 11 depicts a Simulink model with the addition of a series feedback resistor inductor pair, in accordance with some embodiments of the present invention.

FIGS. 12a and 12b depict voltage acting on a transducer as a function of input voltage and instantaneous gap for different feedback capacitor values, in accordance with some embodiments of the present invention.

FIGS. 13a and 13b depict voltage acting on a transducer at 10 MHz as a function of input voltage and instantaneous gap for different feedback resistor values, in accordance with some embodiments of the present invention.

FIGS. 14a and 14b depict voltage acting on a transducer at 10 MHz as a function of input voltage and instantaneous gap for different feedback resistor and inductor values, in accordance with some embodiments of the present invention.

FIGS. 15a and 15b depict the magnitude of the f₀=20 MHz component of the generated average surface pressure as a function of input signal amplitude at 10 MHz without DC bias with series resistor-inductor pair with values of R_{S}=50 kΩ and L_{S}=2.2 mH, respectively, in accordance with some embodiments of the present invention.

FIG. 16a depicts spectrums of generated surface pressure for broadband excitation waveforms for conventional and subharmonic excitation cases with and without feedback, respectively, in accordance with some embodiments of the present invention.

FIG. 17 depicts a pulse-echo response of a CMUT used in the experiment and its frequency spectrum, in accordance with some embodiments of the present invention.

FIG. 18 depicts the frequency spectrum of the received signal with and without resistive feedback where the transducer is excited with a 15-cycle 1.5-MHz tone burst, in accordance with some embodiments of the present invention.

### DETAILED DESCRIPTION

Embodiments of the present invention relate generally to a system and method for ultrasound imaging, and specifically to a system and method for increasing output pressure and reducing distortion using capacitive micromachined ultrasonic transducers (CMUTs) with additional electronics. Embodiments of the present invention provide improved imaging at reduced input voltages. Embodiments of the present invention can utilize multiple configurations including, but not limited to, resistive and/or inductive-resistive gap feedback electronics.

To simplify and clarify explanation, the system is described below as a system for ultrasound imaging. One skilled in the art will recognize, however, that the invention is not so limited. For ease of explanation, certain tools and configurations are used below (e.g., Simulink), however, one skilled in the art will recognize that existing and future tools and/or configurations can be used without departing from the spirit of the invention.

The materials described hereinafter as making up the various elements of the present invention are intended to be illustrative and not restrictive. Many suitable materials that would perform the same or a similar function as the materials described herein are intended to be embraced within the scope of the invention. Such other materials not described herein can include, but are not limited to, materials that are developed after the time of the development of the invention, for example. Any dimensions listed in the various drawings are for illustrative purposes only and are not intended to be limiting. Other dimensions and proportions are contemplated and intended to be included within the scope of the invention.

As mentioned above, a problem with using CMUTs for ultrasound imaging, especially those that require high output pressures, is the non-linear nature of CMUTs. In other words, to generate high output pressures, relatively high AC and/or DC current must be applied to the CMUT membrane. At high current levels, however, when the CMUT membrane comes in close proximity to the electrode(s), the membrane has a tendency to reach a certain point and then “snap” closed. The non-linear nature of the membrane also tends to introduce harmonic vibration into the transmission, which is undesirable. It would be desirable, therefore, to have a method for linearizing the motion of the CMUT membrane over a larger range of motion to enable both increased output pressure and decreased harmonic distortion. It is to such a system that embodiments of the present invention are primarily directed.

Nonlinear 1-D CMUT Model

The basic structure of a CMUT is known. The Applicant herein has filed multiple patents and patent applications that describe a number of different and effective configurations for CMUTs. The Applicant has also provided a number of fabrication and control methods for same. To simplify and clarify explanation of the basic CMUT structure, therefore, the Applicant incorporates herein by reference several of these applications and patents. See, e.g., USPAN 2005/0177045 A1, filed Feb. 7, 2005, entitled, “CMUT Devices and Fabrication Methods”; USPAN 2010/0249605 A1, filed Nov. 1, 2009, entitled, “Harmonic CMUT Devices and Fabrication Methods”; see, also, U.S. Pat. No. 7,612,483, filed Feb. 28, 2005, entitled, “Harmonic CMUT Devices and Fabrication Methods”; U.S. Pat. No. 7,646,133, filed Mar. 11, 2005, entitled, “Asymmetrical Membrane CMUT Devices and Fabrication Methods”; U.S. Pat. No. 8,076,821, filed Jun. 30, 2010, entitled, “Multiple Element Electrode CMUT Devices and Fabrication Methods”.

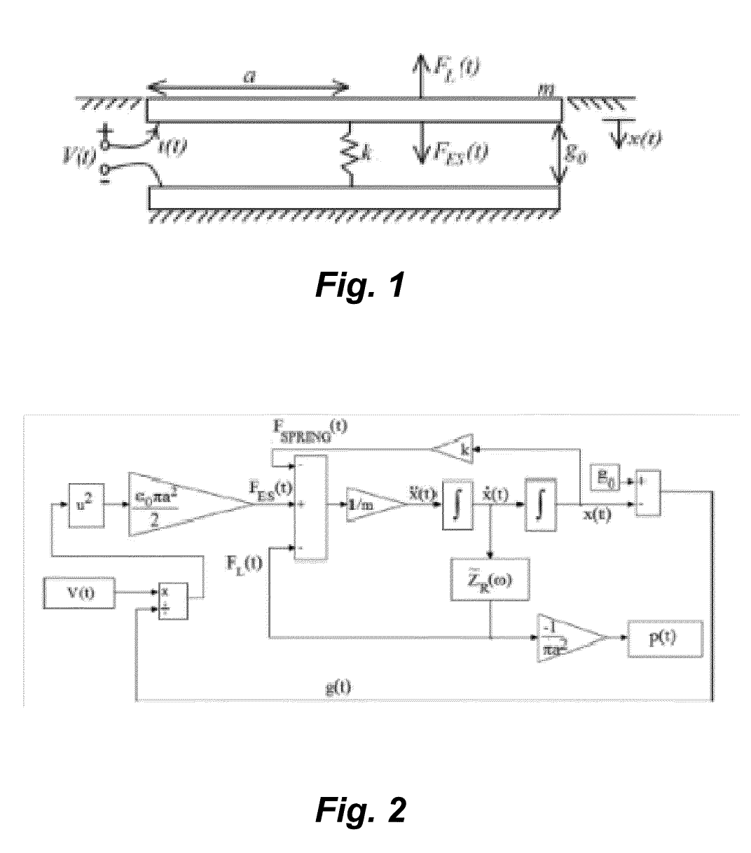

In some embodiments, one of these configurations, a circular membrane CMUT, can be modeled using, for example, Simulink®, or other appropriate modeling software. The CMUT can comprise a 1-D parallel plate capacitor and a circular piston in an infinitely rigid baffle. An exemplary model is shown in FIG. 1, where V(t) is the acting voltage on the transducer, i(t) is the input current, m and k are the mass and the stiffness of the piston, respectively, and g₀ is the initial gap. F_{ES}(t) and F_{L}(t) are total electrostatic and fluid loading acting on the piston, respectively, x(t) is the displacement of the piston, and a is the radius of the piston. The governing differential equations that couple the mechanical and electrical domains are:

$$\begin{matrix}m \ddot{x} ( t ) + kx ( t ) = {F}_{ES} ( t ) - {F}_{L} ( t ) , & ( 1 ) \\ i ( t ) = \frac{d ( C ( t ) V ( t ) )}{d t} , & ( 2 )\end{matrix}$$

where C(t)=(ε₀πa₂)/g(t) is the instantaneous capacitance, ε₀ is the permittivity of free space, and g(t)=g₀−x(t) is the instantaneous gap of the transducer. Defining the Fourier transform of displacement as \tilde{x}(ω), the inverse Fourier transform operator as [symbol] ⁻¹, such that x(t)= [symbol] ⁻¹ {\tilde{x}(ω)}, and the radiation impedance as \tilde{Z}_{R}(ω), the electrostatic and fluid loading can be expressed in Eq. 4:

$$\begin{matrix}{F}_{ES} ( t ) = \frac{{ɛ}_{0} π {a}^{2}}{2} {( \frac{V ( t )}{g ( t )} )}^{2} , & ( 3 ) \\ {F}_{L} ( t ) = {- 1}^{} \{ {\tilde{Z}}_{R} ( ω ) jω \tilde{x} ( ω ) \} & ( 4 )\end{matrix}$$

For a circular piston, the radiation impedance \tilde{Z}_{R}(ω) is given as

$${\tilde{Z}}_{R} ( ω ) = {ρ}_{0} c π {a}^{2} ( 1 - \frac{{J}_{1} ( \frac{2 a ω}{c} )}{\frac{a ω}{c}} + \frac{j {H}_{1} ( \frac{2 a ω}{c} )}{\frac{a ω}{c}} ) . \qquad ( 5 )$$

Here, J₁ is the first-order Bessel function, H₁ is the Struve function, ρ₀ is the density of the immersion medium, and c is speed of sound in the medium. Differential equations (1) and (2) can be solved using Simulink, for example, to simulate average generated surface pressure, p(t), for an arbitrary input signal, V(t), where

$$p ( t ) = \frac{- {F}_{L} ( t )}{π {a}^{2}} . \qquad ( 6 )$$

Piston stiffness, k, can be calculated via finite element analysis using Comsol® (Comsol Inc., Burlington, Mass.), or other suitable technique, by applying a uniform pressure, P, over the circular membrane as

$$k = \frac{P π {a}^{2}}{{x}_{mean}} , \qquad ( 7 )$$

where xₘₑₐₙ is the average displacement of the membrane. Piston mass, m, can then calculated as

$$m = \frac{k}{{( 2 π {f}_{0} )}^{2}} . \qquad ( 8 )$$

where f₀ is the first resonance frequency of the membrane in vacuum and can be calculated via Eigen frequency analysis in Comsol. For analysis, it can be assumed that only the first mode of the membrane is excited when an electrical input signal is applied, and the CMUT membrane is operated in the non-collapsed regime. Other sources of nonlinearity, such as inelastic behavior of materials under large deformations, can be ignored.

The Simulink model which simulates the transient CMUT behavior for an arbitrary input signal is presented in FIG. 2, where the output of the system is the generated average surface pressure, p(t). In the model, the radiation impedance block, \tilde{Z}_{R}(ω), can be implemented using an arbitrary finite impulse response filter, which has the frequency response expressed in Eq. 5. The output pressure, p(t), can then be post processed for harmonic analysis.

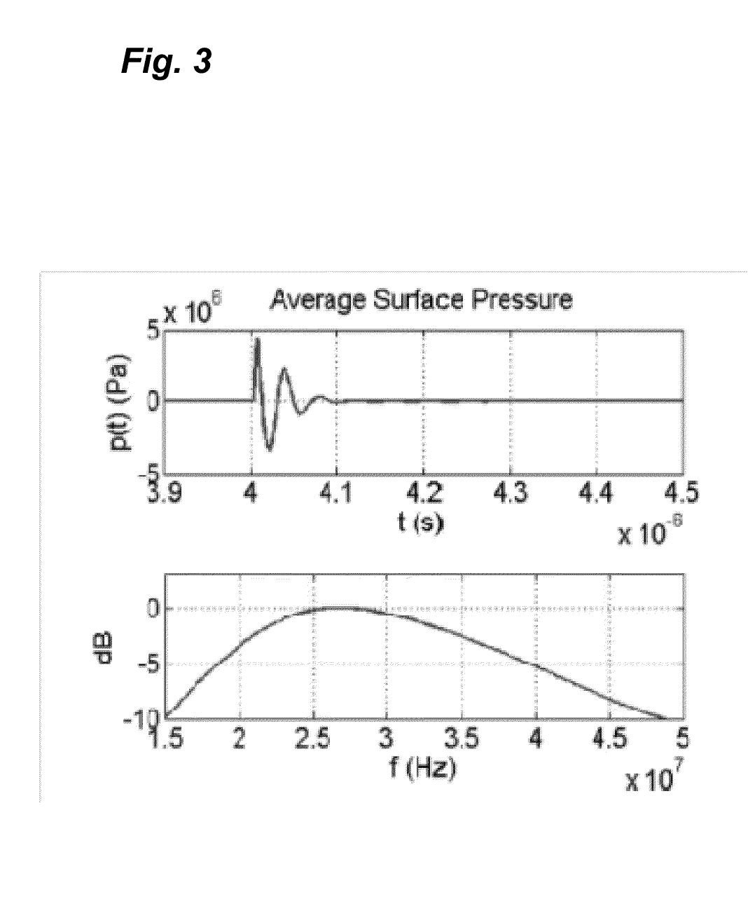

A CMUT with a center frequency of 27 MHz and 3-dB fractional bandwidth of 55%, for example, was designed with the dimensions and material properties listed in Table I to be used in nonlinear harmonic analysis simulations. The surface pressure on the transducer surface was simulated for a 120 V input pulse with a 3-ns pulse width and 120 V DC bias. The response of the transducer is presented in time and frequency domains in FIG. 3. This transducer can then be used in simulations to investigate the nonlinearity in the case of harmonic imaging with a f₀=20 MHz fundamental transmit operation and a 2f₀=40 MHz harmonic receive operation.

TABLE I
CMUT DIMENSIONS AND MATERIAL
PROPERTIES USED IN SIMULATIONS.

| Property | Value | |
|---|---|---|
| Radius, a | 20 | μm |
| Membrane thickness, tₘ | 3 | μm |
| Initial gap, g₀ | 100 | nm |
| Membrane density, ρ | 3270 | kg/m³ |
| Poisson's ratio of membrane, σ | 0.263 | |
| young's modulus of membrane, Y₀ | 3.2 × 10¹¹ | Pa |
| Density of immersion medium, ρ₀ | 1000 | kg/m³ |
| Speed of sound in immersion | 1500 | m/s |
| medium, c | | |

### Nonlinearity Analysis

Eqs. 1-3 show that the nonlinear behavior of the CMUT is at least partially due to the dependency of the electrostatic force on the electrical input signal and instantaneous gap, such that:

$${F}_{ES} ( t ) ∝ {V ( t )}^{2} , \\ {F}_{ES} ( t ) ∝ \frac{1}{{g ( t )}^{2}} . \qquad ( 9 )$$

The CMUT is generally directly driven with a voltage V(t) that includes DC and AC components, i.e., V(t)=V_{DC}+V_{AC}^{cos}(ωt). The square of this signal, as shown in Eq. 10, has a second harmonic content.

$${V ( t )}^{2} = {V}_{DC}^{2} + 2 {V}_{DC} {V}_{AC} cos ( ω t ) + {( {V}_{AC} cos ( ω t ) )}^{2} \\ {V ( t )}^{2} = \frac{{V}_{AC}^{2}}{2} + {V}_{DC}^{2} + 2 {V}_{DC} {V}_{AC} cos ( ω t ) + \frac{{V}_{AC}^{2}}{2} cos * ( 2 ω t ) . \qquad ( 10 )$$

This nonlinearity resulting from the voltage square dependence can be compensated by exciting the transducer with an input signal with frequency f₀/2 without DC bias, where f₀ is the desired fundamental operation frequency. Setting V_{DC}=0 V and ω=2πf₀/2, (10) yields

$$V ( {t}^{2} ) = \frac{{V}_{AC}^{2}}{2} + \frac{{V}_{AC}^{2}}{2} cos ( 2 π {f}_{0} t ) , \qquad ( 11 )$$

so that the electrostatic force only has a DC component in addition to a sinusoidal component at the desired frequency, f₀.

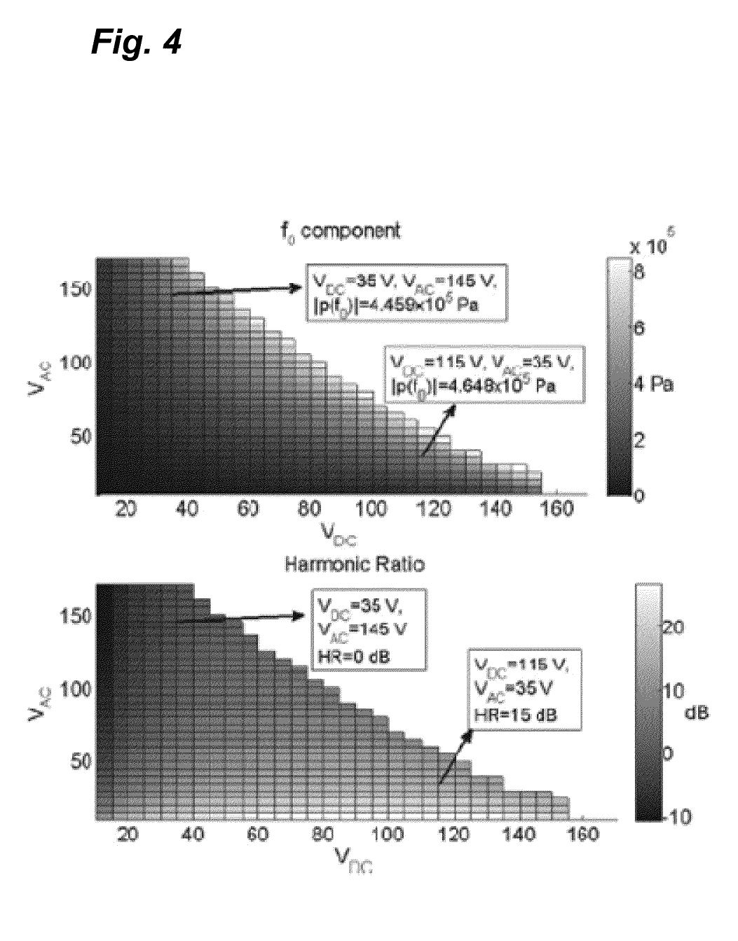

To have a better understanding of the harmonic generation for different drive schemes, the model can be simulated for different stable V_{DC} and V_{AC} combinations. In one case, for example, the membrane can be excited at the fundamental frequency, f₀=20 MHz, and the AC signal can be enveloped with a Gaussian curve with a full-width at half-maximum (FWHM) of 1 μs. The f₀ component and the ratio of 20 to 40 MHz components (harmonic ratio or HR) of the generated surface pressure for the given input signal are presented in FIG. 4. The CMUT can also be driven by a subharmonic signal with no DC bias, i.e., V(t)=V_{AC}E(t)cos(2πf₀/2), where E(t) is the same Gaussian envelope.

As shown in FIG. 4, the same output pressure can be achieved at the fundamental frequency with different V_{DC}-V_{AC} combinations, resulting in different harmonic component amplitudes. Eq. 6 shows that harmonic generation is a function of V_{DC} and V_{AC} such that

$$HR ∝ \frac{{V}_{DC}}{{V}_{AC}} . \qquad ( 12 )$$

Through nonlinear harmonic analysis, the relationship in Eq. 12 can be verified with the simulated results in FIG. 4. ˜460 kPa pressure at 20 MHz can be achieved, for example, with either V_{DC}=35 V and V_{AC}=145 V or V_{DC}=115 V and V_{AC}=35 V, with harmonic ratios of 0 and 15 dB, respectively. The model can then be simulated for subharmonic excitation of the transducer at 10 MHz without DC bias.

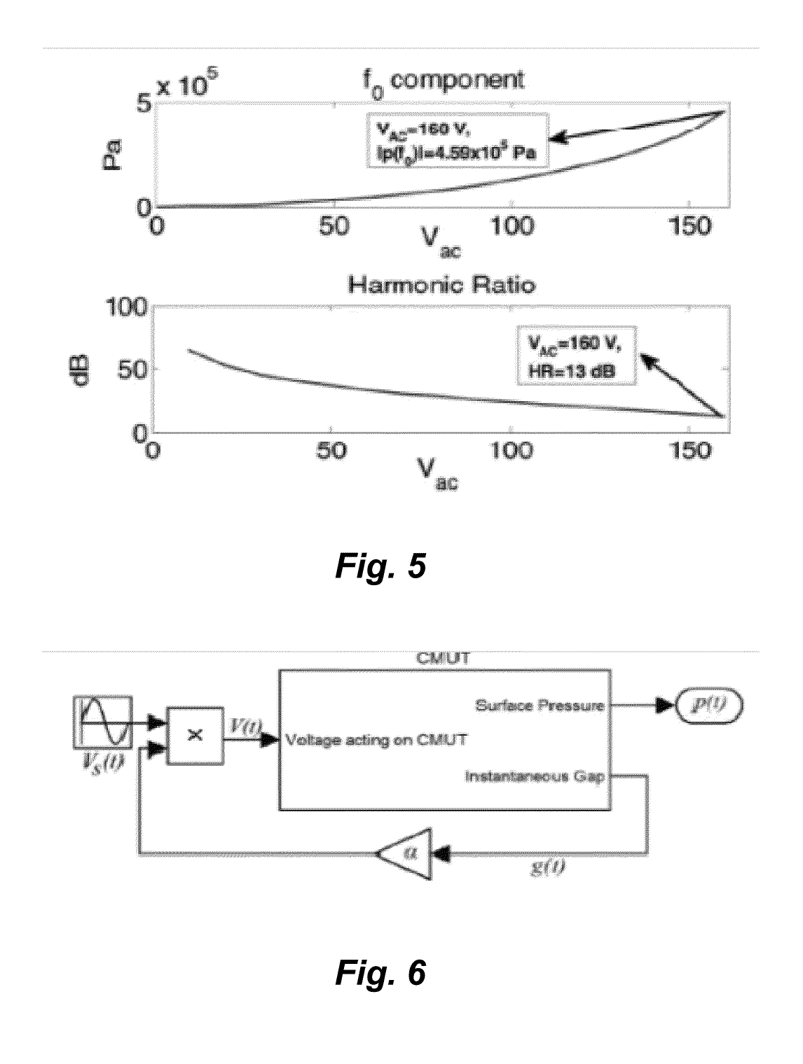

The output pressure component at 20 MHz can also be plotted as a function of the excitation signal amplitude, as shown in FIG. 5, for V_{AC} values which do not collapse the parallel plate. In this case, the same pressure, i.e., ˜460 kPa, can be achieved with V_{AC}=160 V with a harmonic ratio of 13 dB, which shows no improvement over the conventional 20 MHz excitation with V_{DC}=115 V, V_{AC}=35 V. This observation suggests that subharmonic excitation of the transducer does not compensate for the nonlinear distortion by itself, and the non-linearity of the transducer is mainly caused by the inverse gap dependence of the electrostatic force.

### Gap Feedback Linearization

According to Eq. 3, Eqs. 1 and 2 can be linearized if the input voltage signal is scaled with the instantaneous gap with f₀/2 excitation and no DC bias. Substituting the voltage acting on the transducer, α V_{S}(t)g(t), therefore, where α is a constant and V_{S}(t) is the source voltage, yields

$${F}_{ES} ( t ) = \frac{{ɛ}_{0} π {a}^{2} {α}^{2}}{2} {{V}_{S} ( t )}^{2} , \qquad ( 13 )$$

This indicated that the nonlinear behavior resulting from gap dependence can be compensated via nonlinear gap feedback. The remaining nonlinear term V_{S}(t)² can be handled by exciting the transducer at half the operating frequency as explained above. See, Non-Linearity Analysis.

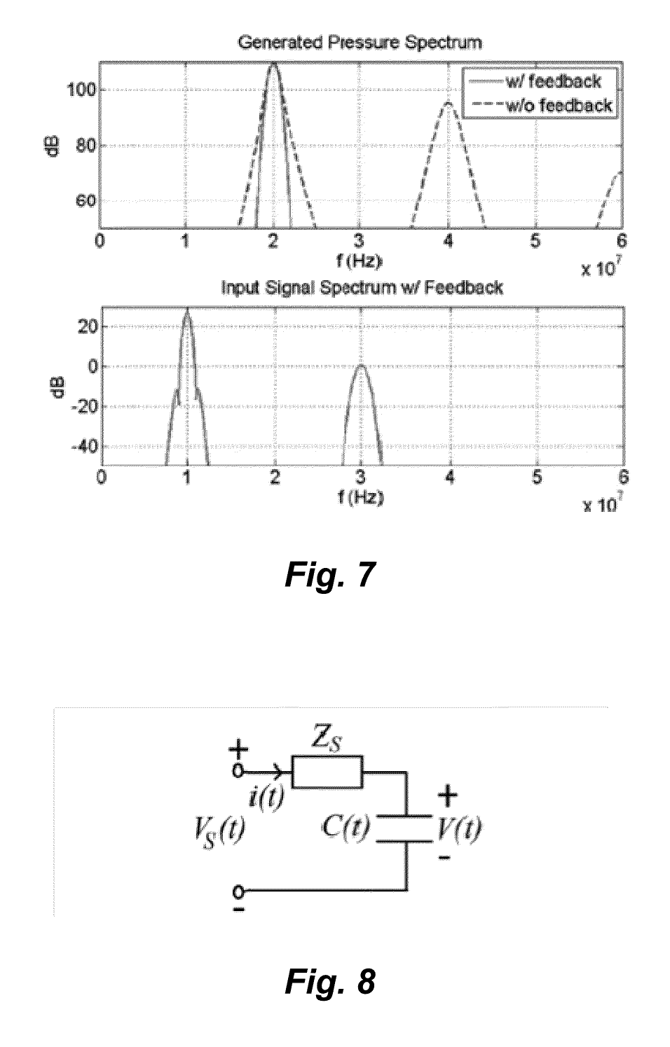

An example of nonlinear feedback topology is depicted in the block diagram in FIG. 6. The CMUT subsystem in the diagram is simply the model shown in FIG. 2, where V(t) is the voltage acting on the transducer, p(t) is the pressure output, and g(t) is the instantaneous gap, which is used as the feedback signal. It should be noted that with f₀/2 excitation, nonlinear gap feedback generates a 3f₀/2 component by distorting the input signal. The effect can be seen in FIG. 7, where a 150 Vₚₑₐₖ, 10 MHz, 1 μs FWHM Gaussian enveloped tone burst is applied to the transducer with gap feedback and no DC bias. As shown, from the frequency-domain perspective, the nonlinear interaction of f₀/2 and 3f₀/2 components in the distorted input signal generates 2 components at f₀ and 2f₀ as the result of the nonlinear behavior of the transducer. The generated f₀ component cancels the second harmonic generation because the electrostatic force is a function of the voltage squared. Hence, the need for complex input signals and fine calibration of the added third-harmonic signal in previous approaches can be avoided.

In essence, the proposed gap feedback method inherently implements charge control of the transducer, because in this case the charge on the CMUT capacitance is linearly proportional to the input voltage, V_{S}(t):

Q(t)=ε₀πα²αV_{S}(t), (14)

where α is the feedback gain. If the transducer is controlled with a charge driver, for example, instead of a voltage source, the electrostatic force acting on the CMUT membrane does not depend on the instantaneous gap. Existing charge control implementations are limited to static operation, however, and are strictly dependent on the parasitic capacitances in the system and require complex charge driving circuitry.

An elegant way of scaling the input voltage with the instantaneous gap can be realized, however, through the addition of a passive electronic component in series to the CMUT driving circuit as shown in FIG. 8. With the addition of series impedance, for example, the voltage acting on the transducer becomes

$$V ( t ) = {V}_{S} ( t ) \frac{g ( t )}{g ( t ) + jω {Z}_{s} {ɛ}_{0} π {a}^{2}} , \qquad ( 15 )$$

with harmonic excitation voltage V_{S}(t)=V_{S}e^{jωt}. If Z_{S} is a function of g(t) such that the denominator of Eq. 15 is constant for example,

$${Z}_{S} ( g ( t ) ) = \frac{K - g ( t )}{{jωɛ}_{0} π {a}^{2}} , \qquad ( 16 )$$

where K is a constant, then the gap feedback can be implemented exactly. If |jωZ_{S}ε₀πα²|>>g(t), the voltage acting on the CMUT can be approximated by

$$V ( t ) \approx {V}_{S} ( t ) \frac{g ( t )}{jω {Z}_{S} {ɛ}_{0} π {a}^{2}} , \qquad ( 17 )$$

so that the input voltage is scaled with the instantaneous gap.

Capacitive Feedback

To extend the actuation range of parallel-plate electrostatic actuators, a series capacitor can be used to extend the stable region of the CMUT in static operation through gap feedback. With Z_{S}=1/jωC_{S} for harmonic excitation, for example, the circuit in FIG. 8 is a nonlinear voltage divider because the CMUT capacitance, C(t), is a nonlinear function of the voltage across the transducer, where the voltage across the CMUT is

$$V ( t ) = {V}_{S} ( t ) \frac{g ( t )}{g ( t ) + \frac{{ɛ}_{0} π {a}^{2}}{{C}_{S}}} . \qquad ( 18 )$$

As the input source voltage increases, therefore, the instantaneous CMUT gap tends to decrease, which results in a decrease in V(t). This negative feedback effect can reduce the nonlinearity and thus stabilize the transducer for a larger displacement range of the CMUT membrane. Higher excitation voltages are required, however, as a trade-off for the same membrane displacement because of the voltage division nature of the circuit. The series capacitance value relative to the instantaneous CMUT capacitance determines the voltage division ratio and, hence, the harmonic generation. The approximation in Eq. 18 can be written in this case as

$$V ( t ) \approx {V}_{S} ( t ) \frac{g ( t ) {C}_{S}}{{ɛ}_{0} π {a}^{2}} , \\ {C}_{S} ≪ C ( t ) , \\ V ( t ) \approx {V}_{S} ( t ) , \\ {C}_{S} ≫ C ( t ) . \qquad ( 19 )$$

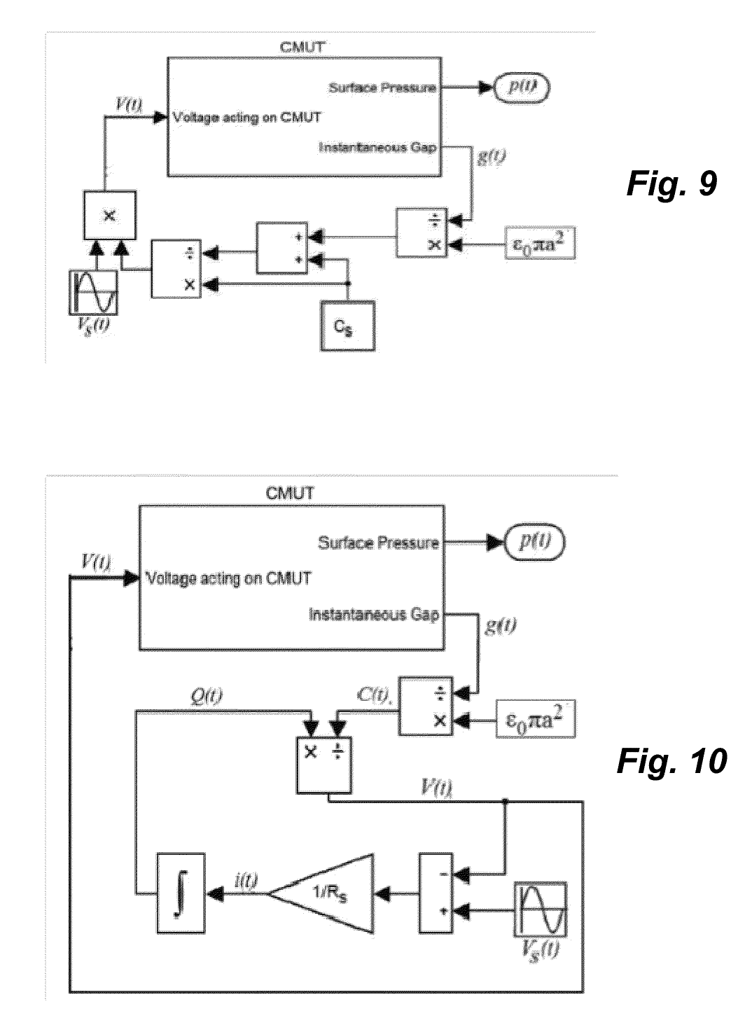

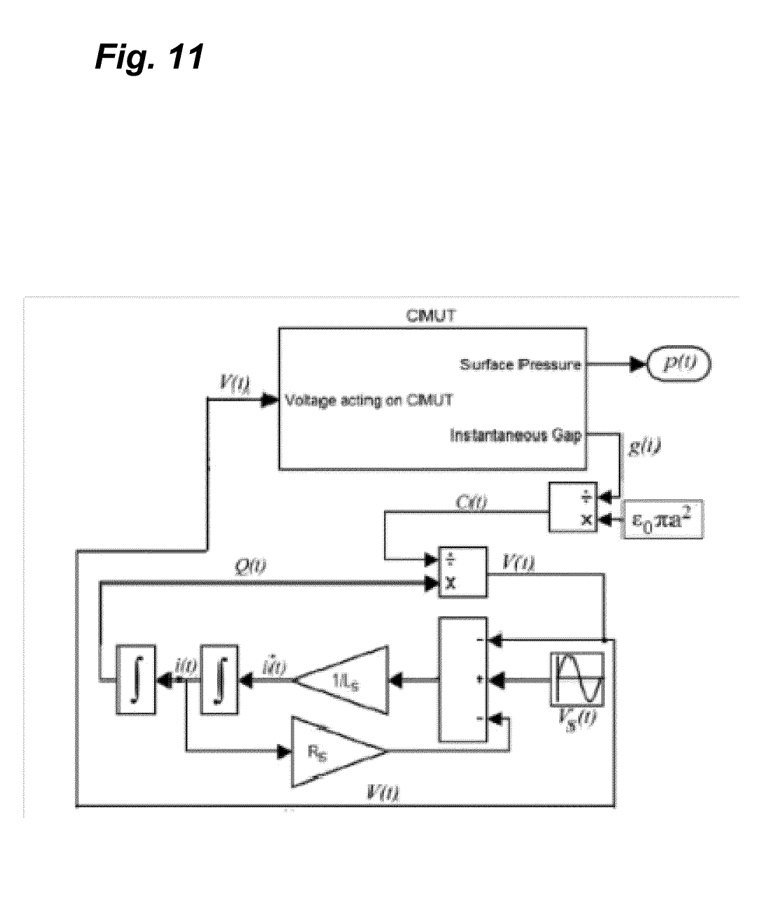

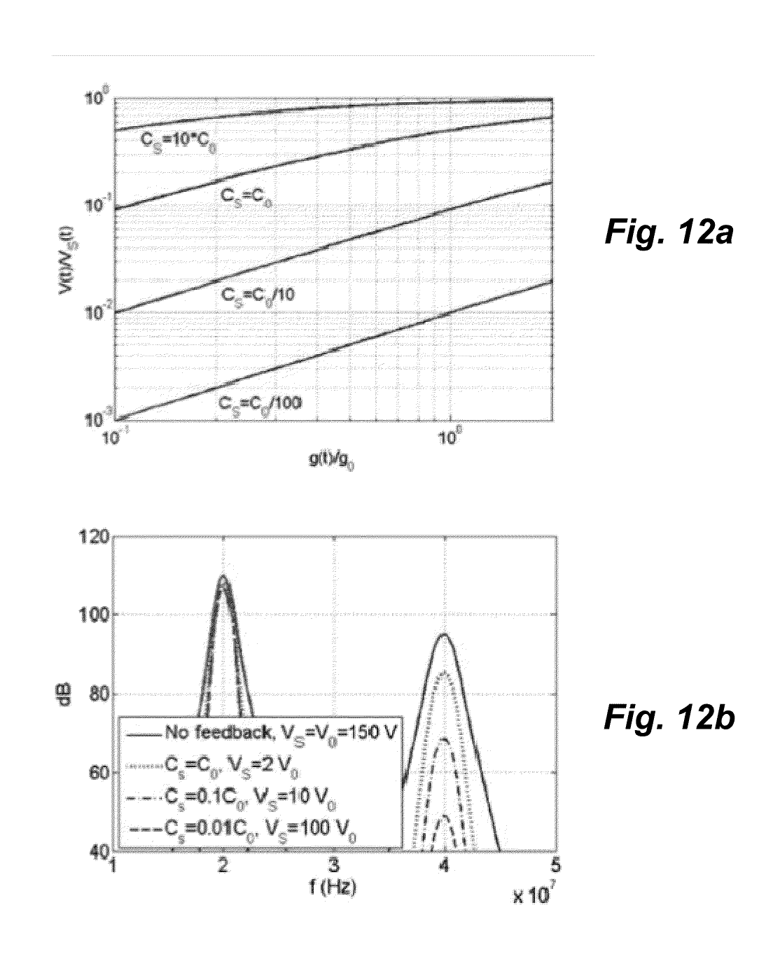

To simulate a system with series impedances, the Simulink model can be modified to include the passive electrical elements as shown in FIGS. 9, 10, and 11 for different feedback topologies. As shown in FIG. 12a, for example, the simulated voltage across the transducer, normalized by the input voltage, is plotted as a function of instantaneous normalized gap. As expected, the relationship between V(t) and g(t) is more linear for smaller values of C_{S} compared to the initial CMUT capacitance. FIG. 12b, on the other hand, shows that for the same output pressure at the fundamental frequency, the harmonic ratio improves with feedback. In other words, with decreasing C_{S} values, harmonic ratio improves at the expense of increased V_{S}. For the modeled transducer, a 10 dB reduction in 2f₀ component is achieved with C_{S}=(ε₀πα²)/g₀ by doubling the excitation voltage to generate the same pressure output at f₀=20 MHz (the dotted curve).

In a preferred embodiment, the series feedback capacitor can be designed such that its capacitance changes with CMUT membrane motion, satisfying the relation

$${C}_{S} ( g ( t ) ) = \frac{{ɛ}_{0} π {a}^{2}}{K - g ( t )} , \qquad ( 20 )$$

then a desirable gap feedback is provided because the denominator of Eq. 18 becomes a constant. This indicates the possibility of an electromechanical device to be used as a variable feedback capacitor to approximate the gap scaling of the input voltage more accurately than the fixed series capacitor case.

Resistive Feedback

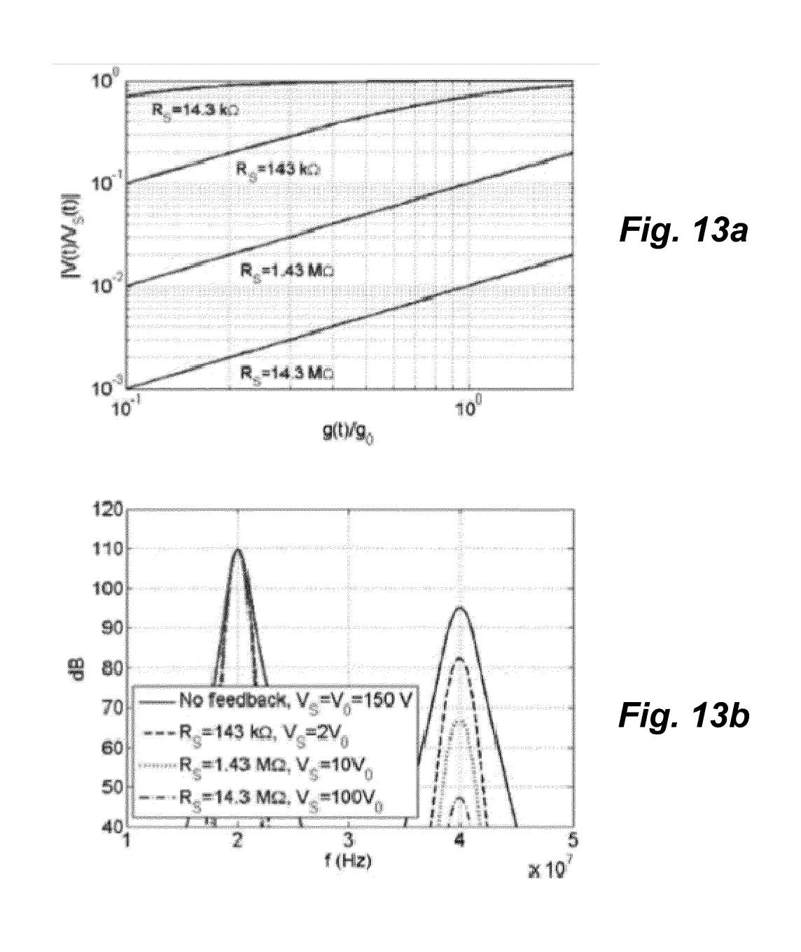

In some embodiments, a resistor can be used as the feedback component. Where Z_{S}=R_{S}, the circuit in FIG. 8 becomes a nonlinear, first-order, low-pass filter where the output is V(t). Similar to the capacitive feedback case, the magnitude of the voltage across the transducer becomes linearized as a function of CMUT gap as the feedback resistor becomes larger. Comparing FIG. 12 to FIG. 13, therefore, for the same fundamental and second harmonic pressure amplitudes, the required feedback resistor value can be calculated using the corresponding series capacitance value for the same input signal V_{S}(t), such that R_{S}=|1/(jωC_{S})| where ω is the excitation frequency. Because the circuit acts as a low-pass filter, the required feedback resistor value is inversely proportional to the excitation frequency for the same harmonic reduction. This is because Eq. 15 is a function of frequency for Z_{S}=R_{S}. In contrast, capacitive feedback is not dependent on frequency. In other words, the nonlinearity is dependent only on the relative value of the feedback capacitor compared to the CMUT capacitance.

### RL Feedback

In some embodiments, the capacitive nature of the CMUT in the electrical domain can be exploited by connecting a series resistor and a series inductor to the transducer. The resulting circuit becomes a nonlinear, second-order, low-pass filter, and the resonant behavior of the resulting electrical circuit can be used to linearize Eqs. 1 and 2 without the need for increased excitation voltage. With the addition of a series resistor-inductor pair, the differential equation governing the electrical domain of the transducer becomes

$${V}_{S} ( t ) = {R}_{S} i ( t ) + {L}_{S} \frac{d i ( t )}{d t} + \frac{1}{C ( t )} {\int }_{0}^{i} i ( τ ) d τ , \qquad ( 21 )$$

where the voltage across the transducer generating electrostatic force is

$$V ( t ) = \frac{1}{C ( t )} {\int }_{0}^{i} i ( τ ) d τ . \qquad ( 22 )$$

With harmonic excitation signal V_{S}(t), the nonlinear transfer function between V_{S}(t) and V(t) becomes

$$V ( t ) = {V}_{S} ( t ) \frac{g ( t )}{g ( t ) + ( jω {R}_{S} - {ω}^{2} {L}_{S} ) {ɛ}_{0} π {a}^{2}} . \qquad ( 23 )$$

and the damping ratio and the resonance frequency of the filter are

$${ω}_{0} = \frac{1}{\sqrt{{L}_{S} C ( t )}} , \\ ξ = \frac{{R}_{S}}{2} \sqrt{\frac{C ( t )}{{L}_{S}}} . \qquad ( 24 )$$

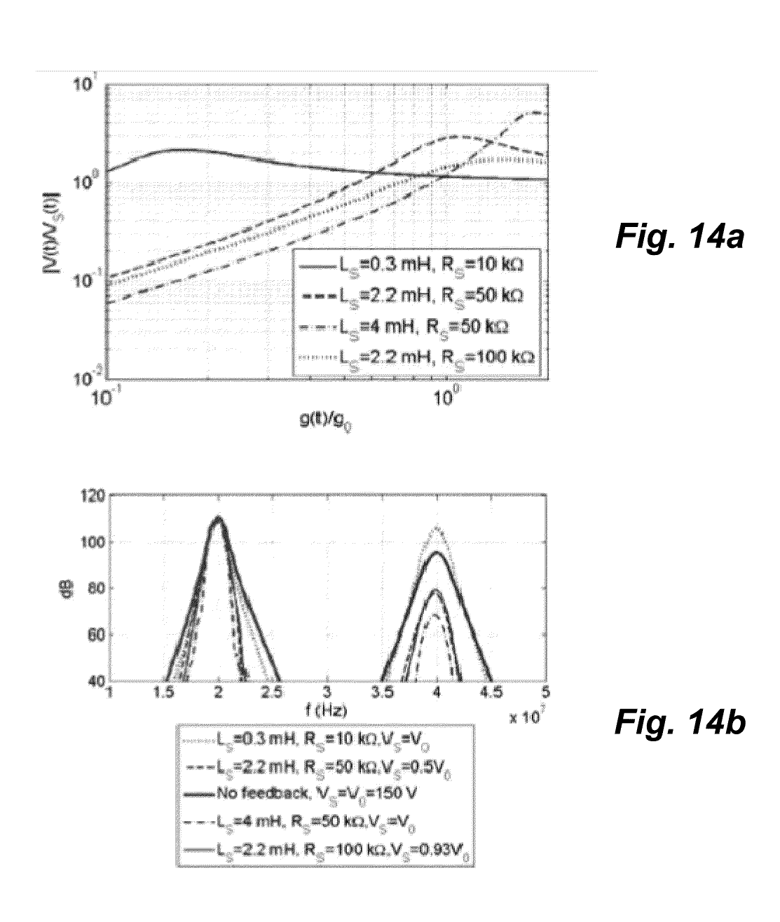

It is desirable, therefore to carefully select the series resistor and inductor values such that the relationship between V(t) and g(t) is linearized for g(t) in the range from 0 to g₀. As presented in FIG. 14a, for example, if the series inductor is chosen so that the resonance frequency of the circuit is higher than the excitation frequency (as indicated by the solid line) the voltage acting on the transducer decreases with increasing gap for most of the range. This is the opposite of the desired operation. In other words, this results in more nonlinear behavior of the transducer, because the harmonic distortion of the transmitted pressure signal increases for the same excitation signal whereas the fundamental component remains unchanged.

For the other cases in FIG. 14a, where ω₀<ω and ω is the excitation frequency, the desired feedback is satisfied for most of the gap range. With that approach, therefore, the gap-CMUT voltage relationship can be optimized for the harmonic distortion and excitation signal amplitude for a given output pressure and at the fundamental frequency. The corresponding simulation results are shown in FIG. 14b. FIG. 14b shows that by using proper RL feedback, the second harmonic component of the generated pressure can be decreased by more than 20 dB without increasing the excitation signal. Moreover, because of the resonant behavior of the circuit, higher output pressure and lower harmonic distortion are achievable for a given excitation signal depending on the damping coefficient of the filter.

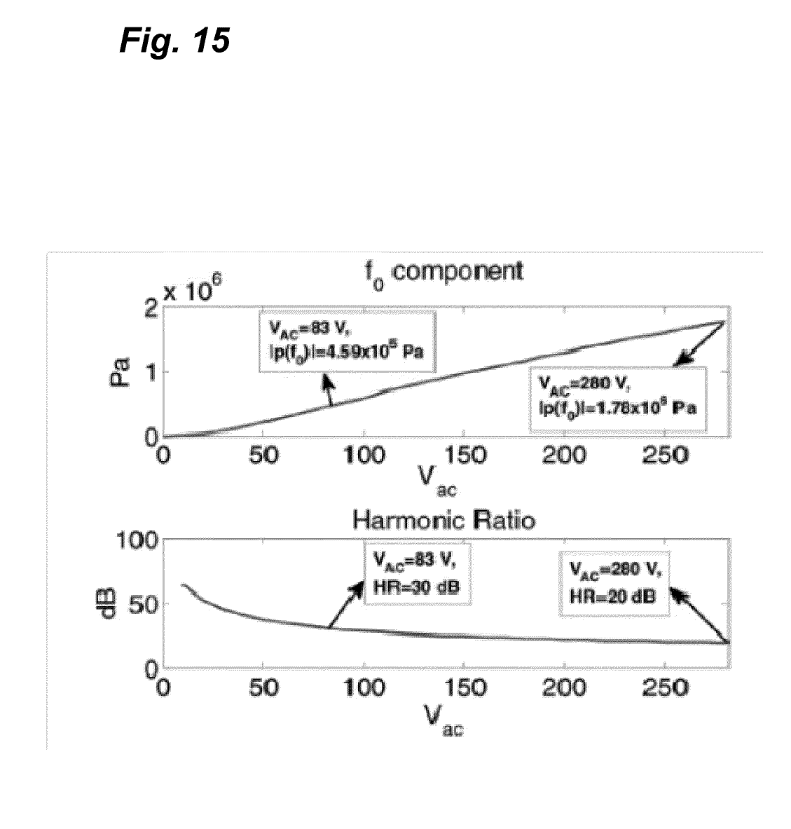

Because the collapse phenomenon for CMUTs is related to the nonlinearity of the transducer, feedback linearization and charge control extends the stable displacement region of the CMUT. FIG. 15, for example, plots the output pressure at the fundamental frequency as a function of AC voltage amplitude for one L-R feedback case. In comparison to FIG. 5, which plots the result for the non-feedback case, it is seen that not only is the relationship between the excitation signal and pressure output at f₀ linearized with gap feedback, but it is possible to increase the transmit sensitivity and the maximum pressure at the fundamental frequency of the transducer.

In addition, with any of the series impedance methods, the second-harmonic levels can be reduced by more than 25 dB below the fundamental for a broadband device, making it suitable for harmonic imaging. This is achieved with either reasonably higher voltages using R and C feedback, or with reduced voltage levels with LR feedback, at the expense of somewhat more difficult implementation in some applications (e.g., large arrays). Because the stable region of the transducer is extended with gap feedback linearization, however, the maximum pressure generated at the desired frequency can be increased without collapsing the membrane. Thus, linearization of the CMUT can be useful for high-intensity applications like high-intensity focused ultrasound (“HIFU”) applications.

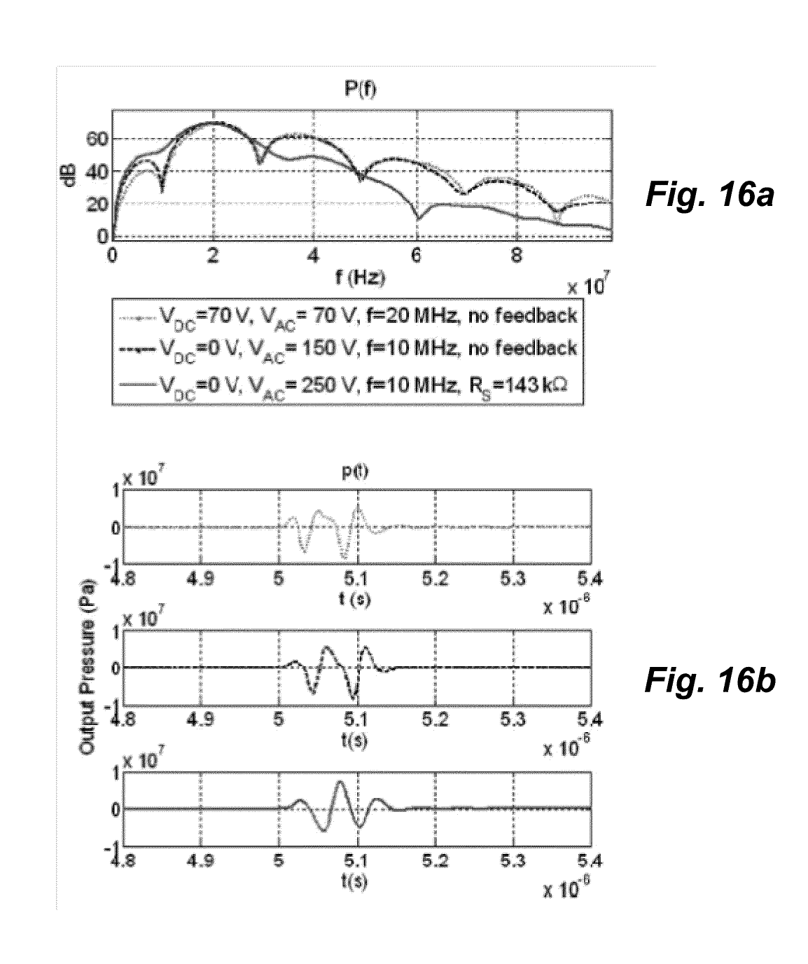

Embodiments of the present invention can also be evaluated for broadband excitation waveforms, which are typically used in harmonic imaging. The model can be simulated for conventional operation, for example, with a 2-cycle, 20-MHz input signal, subharmonic excitation, and with and without resistive feedback. For subharmonic excitation cases, however, the input signal can be a 1-cycle 10-MHz tone burst to achieve similar bandwidth around 20 MHz. The simulation results for generated surface pressure are shown in FIGS. 16a and 16b in the frequency and time domains, respectively. As shown, conventional and subharmonic-only excitations result in highly distorted pressure waveforms. With resistive feedback, on the other hand, an approximate 10 dB reduction in the second harmonic can be achieved and higher-order harmonics are also suppressed more effectively. The results show that the gap feedback method can be applied to broadband imaging signals as well as narrowband inputs.

An important aspect of the proposed method is that it does not require any changes in the mechanical CMUT design to limit the frequency bandwidth. For applications like harmonic imaging, for example, the gap feedback circuit can be used only for transmission with reduced harmonics. This prevents effects on the bandwidth in receive mode, for example. Because CMUT design is independent from the linearization method, any generic CMUT can be linearized with the gap feedback method.

A possible implementation of the proposed method in array format could be based, for example, on a dual-electrode CMUT structure, where the transmit and receive electrodes embedded in the transducer membrane are electrically isolated. With the dual-electrode structure, for example, the same element can be used for harmonic imaging by utilizing gap feedback in the transmit path with subharmonic excitation and no DC bias without little or no negative effect on the separately biased receiver electrode and receiver electronics, or on receiver bandwidth.

Of course, regardless of the type of feedback used, the actual circuitry can be implemented in a number of ways. In some embodiments, for example, the CMUT and the feedback circuitry can be implemented on the same substrate. In other embodiments, the CMUT can be manufactured on a first substrate and the feedback components can comprise an integrated circuit on a second substrate. In still other embodiments, the feedback components can be separate components (e.g., individual, non-integrated components) on the same or separate substrates.

### Example 1

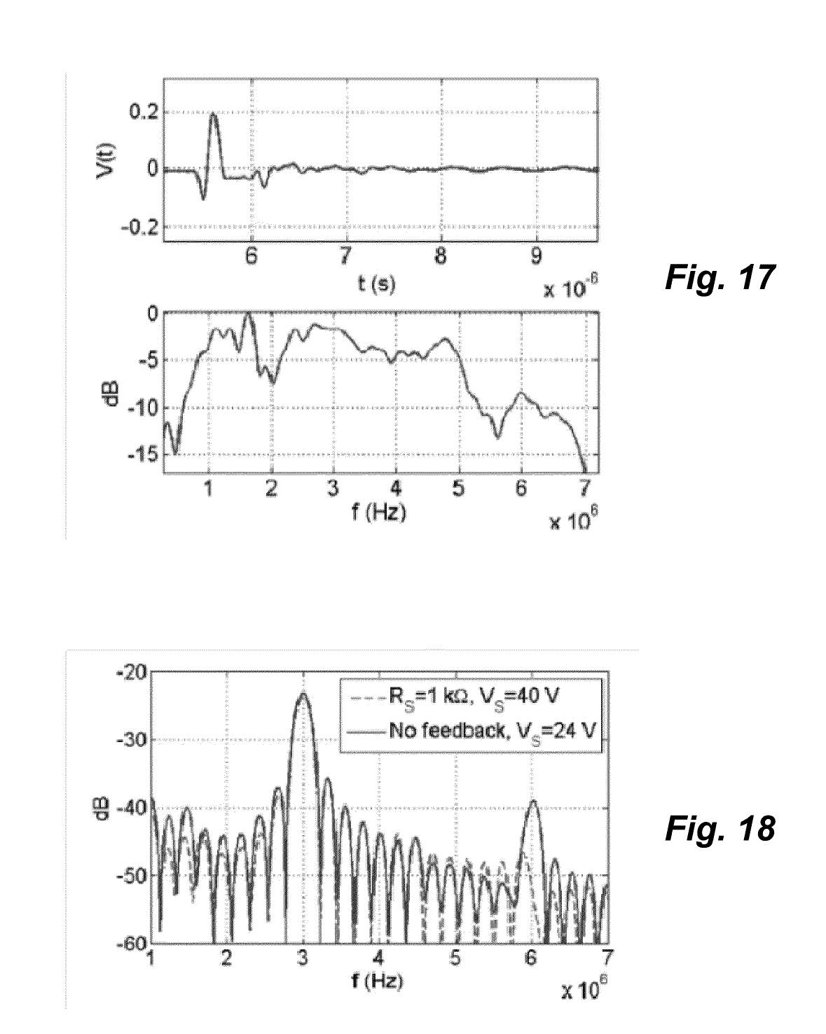

A CMUT with low collapse voltage and low center frequency was chosen so that the driver amplifier would be linear from its output up to the collapse voltage of the CMUT (i.e., where the response gets highly nonlinear). This ensures that the entire voltage range can be explored and that the major source of nonlinearity in the measurement is the CMUT behavior. A CMUT was fabricated with center frequency of 3 MHz, 133% (1 to 5 MHz) effective fractional bandwidth, and a static collapse voltage of 24 V. FIG. 17 shows the measured pulse echo response of the CMUT and its spectrum when excited with a short pulse.

A pair of these transducers can be used in a transmit/receive configuration for harmonic distortion measurements. The receiver is biased to 22 V (e.g., close to collapse) to create high receive sensitivity. FIG. 18 shows the received pressure spectrum when the transmitting CMUT is excited by a 24 Vₚₑₐₖ, 1.5 MHz, 15 cycle tone burst for the case without feedback, i.e., direct connection to the amplifier. The excitation is a large signal AC current at half the desired frequency (e.g., 1.5 MHz) with no DC bias. In this case, the harmonic signal at 6 MHz is 15 dB below the desired 3 MHz output.

For gap feedback operation, on the other hand, the series resistor approach was used for simplicity. First, the capacitance of the transducer was measured with a network analyzer. In this case, it was approximately 120 pF. Based on this, an appropriate (1 kΩ) resistor was connected in series with the amplifier to construct a low-pass filter with a cut-off frequency of 1.5 MHz. With this configuration, with only the transmitter input circuitry changed, the same output pressure at 3 MHz is received with a 40 V peak AC signal at 1.5 MHz, but the harmonic component at 6 MHz is reduced by more than 10 dB (as shown by dashed lines in FIG. 18). This effectively demonstrates that a gap feedback implementation significantly reduces the harmonic generation of a broadband CMUT with a moderate increase in the applied AC signal level.

A variety of gap feedback methods have been disclosed to increase output pressure and reduce harmonic distortion. As shown, a series feedback capacitor improves the harmonic ratio and increases the maximum pressure that can be generated at the expense of input voltage. In some embodiments, a series resistance utilizing resistive feedback can improve the harmonic ratio where the resulting circuit is a first-order low-pass filter. A series resistor-inductor pair, on the other hand, results in second-order filter response. With appropriately selected values in this configuration, the same pressure can be achieved at the fundamental frequency with lower input voltage. As with other feedback configurations, the maximum output pressure can also be increased at the fundamental frequency. The method can also be used for the broadband excitation signals used for imaging applications.

While several possible embodiments are disclosed above, embodiments of the present invention are not so limited. For instance, while several possible configurations and components have been disclosed (e.g., resistive and inductive-resistive feedback), other suitable methods, components, materials, and layouts could be selected without departing from the spirit of the invention. In addition, the location and configuration used for various features of embodiments of the present invention can be varied according to a particular application or probe that requires a slight variation due to, for example, the materials used and/or space or power constraints. Such changes are intended to be embraced within the scope of the invention.

The specific configurations, choice of materials, and the size and shape of various elements can be varied according to particular design specifications or constraints requiring a device, system, or method constructed according to the principles of the invention. Such changes are intended to be embraced within the scope of the invention. The presently disclosed embodiments, therefore, are considered in all respects to be illustrative and not restrictive. The scope of the invention is indicated by the appended claims, rather than the foregoing description, and all changes that come within the meaning and range of equivalents thereof are intended to be embraced therein.

1. A device for ultrasound imaging comprising:
a capacitive micromachined ultrasonic transducer (CMUT) disposed on a substrate and comprising a membrane; and
one or more control components;
wherein the control components apply a first signal to the CMUT that is inversely proportional to a gap between the membrane and the substrate.

2. The device of claim 1, wherein the first signal is a DC voltage signal.

3. The device of claim 1, wherein the first signal is an AC voltage signal.

4. The device of claim 1, wherein the first signal is a combined DC and AC voltage signal.

5. The device of claim 1, further comprising:
gap circuitry for determining the gap between the membrane and the substrate.

6. The device of claim 5, wherein the control components are disposed on the same substrate as the CMUT.

7. The device of claim 5, wherein the CMUT is disposed on a first substrate and the control components are disposed on a second substrate.

8. The device of claim 1, wherein the control components comprise one or more resistors.

9. The device of claim 1, wherein the control components comprise one or more resistors and one or more inductors.

10. The device of claim 1, further comprising:
a first electrode disposed on the membrane; and
a second electrode disposed on the substrate;
wherein the first signal is a voltage differential applied across the first and second electrodes.

11. A device for ultrasound imaging comprising:
a substrate;
a capacitive micromachined ultrasonic transducer (CMUT) comprising a membrane and disposed on the substrate;
a first electrode disposed within the membrane and configured to receive ultrasonic signals for transmission and to receive bias voltages for positioning the membrane for transmission and reception of ultrasonic waves;
a second electrode disposed on the substrate and set off from the membrane to define a cavity positioned beneath the membrane; and
one or more control components;
wherein the membrane can fluctuate in the cavity based on the application of an electrical signal across the first electrode and the second electrode; and
wherein the control components apply a signal to the first and second electrodes that is inversely proportional to a gap between the membrane and the substrate.

12. The device of claim 11, further comprising:
feedback circuitry for determining the gap between the membrane and the substrate.

13. The device of claim 11, further comprising a third electrode disposed within the membrane and configured to receive ultrasonic signals for transmission and to receive bias voltages for positioning the membrane for transmission and reception of ultrasonic waves.

14. A method for ultrasound imaging comprising:
providing a CMUT with a membrane and disposed on a substrate;
applying a first signal to the CMUT that is inversely proportional to a gap between the membrane and the substrate to improve the linearity of the motion of the membrane.

15. The method of claim 14, further comprising:
determining the gap between the substrate and the membrane using feedback circuitry.

16. The method of claim 15, further comprising:
wherein the feedback circuitry comprises one or more inductors in series with the CMUT.

17. The method of claim 14, wherein the first signal comprises an AC component at approximately one half the desired pressure output frequency and no DC component.

18. The device of claim 1, wherein the first signal comprises an AC component at approximately one half the desired pressure output frequency.

19. The device of claim 1, wherein the gap corresponds to the distance between the substrate and the average displacement of the membrane (Xₘₑₐₙ).

20. The device of claim 11, further comprising a third electrode disposed within the membrane;
wherein the control components apply a first signal across the first electrode and the second electrode and a second signal across the third electrode and the second electrode.
